(19) United States
(12) Patent Application Publication
(10) Pub. No.: US 2018/0181310 A1
(43) Pub. Date: Jun. 28, 2018

(54) SYSTEM AND METHOD FOR DISK IDENTIFICATION IN A CLOUD BASED COMPUTING ENVIRONMENT

(71) Applicant: CloudEndure Ltd., Ramat Gan (IL)

(72) Inventors: Leonid FEINBERG, Ramat HaSharon (IL); Ophir SETTER, Ramat Gan (IL); Sigal WEINER, Holon (IL); Ofir EHRLICH, Netanya (IL)

(73) Assignee: CloudEndure Ltd., Ramat Gan (IL)

(21) Appl. No.: 15/853,788

(22) Filed: Dec. 23, 2017

Related U.S. Application Data
(60) Provisional application No. 62/438,785, filed on Dec. 23, 2016.

(51) Int. Cl. G06F 3/06

(52) U.S. Cl. CPC G06F 3/065; H04L 67/10; G06F 3/067; G06F 3/0619

(57) ABSTRACT

A system and method for identifying corresponding disks. The method includes determining identifying information of a primary disk, wherein the primary disk is a logical disk; causing the primary disk to be enlarged to create a first additional disk space; causing primary metadata to be written to the first additional disk space, wherein the primary metadata includes the identifying information of the primary disk; determining a corresponding replicated disk that corresponds to the primary disk by comparing the primary metadata to replicated metadata associated with the replicated disk, wherein the replicated disk is a logical disk; and matching the corresponding replicated disk with the primary disk.

### CROSS-REFERENCE TO RELATED APPLICATIONS

This application claims the benefit of U.S. Provisional Application No. 62/438,785 filed on Dec. 23, 2016, the contents of which are hereby incorporated by reference.

### TECHNICAL FIELD

The present disclosure relates generally to disk replication, and more specifically to disk identification and enlargement for replication over a cloud based computing environment.

### BACKGROUND

Replication of disks in a cloud-based computing environment (CBCE) is often desired for a variety of reasons, including for backup management and to provide quick access to replicated copies of disks, for example when determining the optimal replicated copy to access based on a user's proximity to a disk's physical location. Performing certain tasks over a replication system, particularly automated ones, can introduce challenges. For example, a successful replication of a disk may include mirroring a primary disk's file structure to ensure that disk input and output operations and commands intended for the primary disk can be successfully executed on the replicated disk as well. Further, when backing up data from a primary disk to a replication system having a plurality of replicated disks, it is crucial to identify which replicated disk corresponds to the primary disk in order to backup, update, or access the correct disk.

One problem that can arise while using a replication system is if the replicated disk contains the same data as the primary disk, but the data is arranged, named, labelled or addressed differently such that a replication system is unable to identify a corresponding replication disk. For example, the total memory allocated, in terms of size, to the replicated and primary disks may be identical but the number of memory units used may not be. Further, a replicated machine and primary machine may each have two storage disks, but have different names or addresses for them. If, for example, an instruction intended to be executed on a primary machine having a single disk is rerouted to a replicated machine, where the replicated machine includes a plurality of disks, it first must be determined which of the plurality of replicated disks corresponds to the intended primary disk. This may not be immediately evident, even when comparing the size, label, or address of the disks.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for identifying corresponding disks. The method includes determining identifying information of a primary disk, wherein the primary disk is a logical disk; causing the primary disk to be enlarged to create a first additional disk space; causing primary metadata to be written to the first additional disk space, wherein the primary metadata includes the identifying information of the primary disk; determining a corresponding replicated disk that corresponds to the primary disk by comparing the primary metadata to replicated metadata associated with the replicated disk, wherein the replicated disk is a logical disk; and matching the corresponding replicated disk with the primary disk.

Certain embodiments disclosed herein also include a non-transitory computer readable medium having stored thereon instructions for causing a processing circuitry to perform a process, where the process includes determining identifying information of a primary disk, wherein the primary disk is a logical disk; causing the primary disk to be enlarged to create a first additional disk space; causing primary metadata to be written to the first additional disk space, wherein the primary metadata includes the identifying information of the primary disk; determining a corresponding replicated disk that corresponds to the primary disk by comparing the primary metadata to replicated metadata associated with the replicated disk, wherein the replicated disk is a logical disk; and matching the corresponding replicated disk with the primary disk.

Certain embodiments disclosed herein also include a system for identifying corresponding disks, where the system includes a processing circuitry; and a memory, the memory containing instructions that, when executed by the processing circuitry, configure the system to: determine identifying information of a primary disk, wherein the primary disk is a logical disk; cause the primary disk to be enlarged to create a first additional disk space; cause primary metadata to be written to the first additional disk space, wherein the primary metadata includes the identifying information of the primary disk; determine a corresponding replicated disk that corresponds to the primary disk by comparing the primary metadata to replicated metadata associated with the replicated disk, wherein the replicated disk is a logical disk; and match the corresponding replicated disk with the primary disk.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram of a primary machine of a replication system according to an embodiment.

FIG. 2 is a network diagram of a replication system including primary machines, replicated machines, and a synchronizer, according to an embodiment.

FIG. 3 is a flowchart illustrating a method of identifying a replicated disk corresponding to a primary disk according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

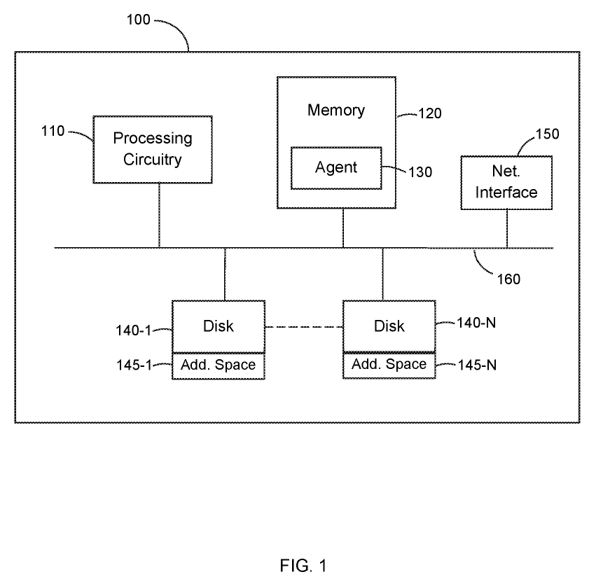

FIG. 1 is a block diagram of a primary machine 100 of a replication system according to an embodiment. The primary machine 100 includes a processing circuitry 110, a memory 120, and one or more primary disks 140-1 to 140-N, where N is an integer equal to or greater than 1 (hereinafter referred to individually as a primary disk 140 and collectively as primary disks 140, merely for simplicity purposes). In an embodiment, the memory 120 includes instructions to execute a replication agent 130, as discussed herein below. The primary machine 100 may further include a network interface 150 to connect to a network. In an embodiment, the components of the primary machine 100 may be communicatively connected via a bus 160.

In certain embodiments, the primary machine 100 may be a server, a physical machine, a virtual machine, a service, and the like. A physical machine or a virtual machine may be, for example, a web server, a database server, a cache server and the like. A service may be a network architecture management service, a load balancing service, an auto scaling service, a content delivery network (CDN) service, a network address allocation service, a database service, a domain name system (DNS) service, and the like. The primary machine 100 may be part of a first cloud-based computing environment (CBCE).

The processing circuitry 110 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 120 may be a volatile memory such as, but not limited to, random access memory (RAM), or non-volatile memory (NVM), such as, but not limited to, flash memory. In an embodiment, the memory 120 is configured to store software. Software shall be construed broadly to mean any type of instruction, whether referred to as software, firmware, middleware, microcode, hardware description language, or otherwise. Instructions may include code (e.g., in source code format, binary code format, executable code format, or any other suitable format of code). The instructions, when executed by the processing circuitry 110, perform the various processes described herein. The software may include instructions to execute commands of the replication agent 130. The replication agent 130 may reside on the primary machine 100 to monitor activity thereof and to send, for example, disk access instructions to a replicated machine in a second CBCE. In some embodiments the replication agent 130 may be communicatively connected to the primary machine 100, without residing thereon.

The disks 140 include one or more logical disks. The logical disks are stored on one or more physical drives, such as magnetic hard disk drives, solid state drives, network-attached storages (NAS), storage area network (SAN) disks, and the like. A logical disk is a virtual volume that provides data storage within a physical drive. Each physical drive may contain one or more logical disks stored thereon. Partitioning a single physical drive into multiple logical disks allows for more precise and organized control over data stored on the physical drive. The primary machine 100 may include one or more physical disks, where each physical disk may include one or more logical disks. As discussed herein below, each logical disk 140 may be expanded to include additional disk space 145-1 to 145-N (hereinafter referred to as additional disk space 145, merely for simplicity purposes). The additional disk space 145 may be stored on the same physical drive on which the logical disk 140 is stored. In an embodiment, the replication agent 130 is configured to expand one or more of the logical disks 140 to include additional storage 145.

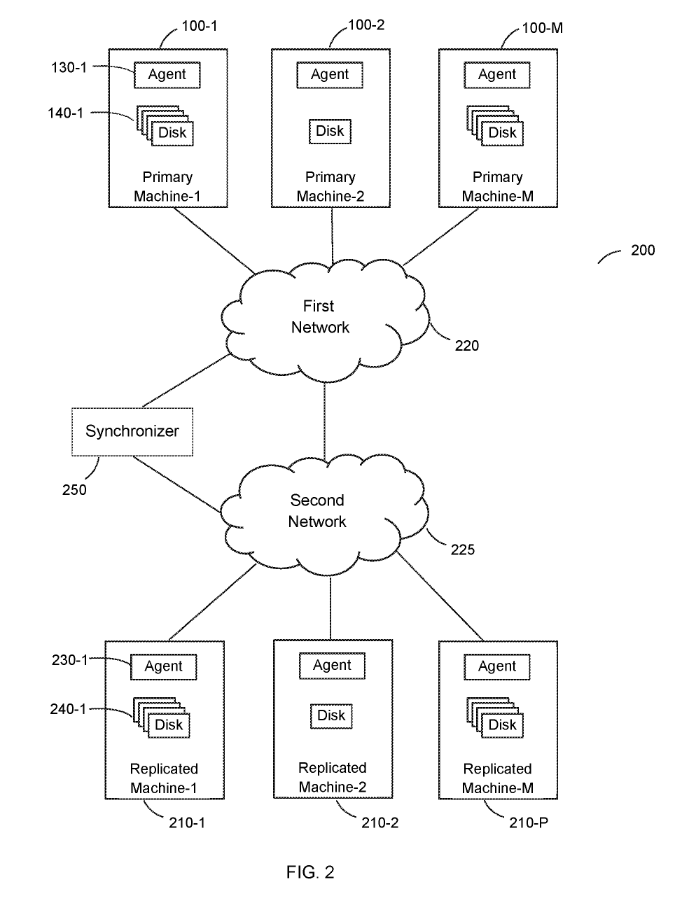

FIG. 2 is a network diagram of a replication system 200, including primary machines 100-1 to 100-M, replicated machines 210-1 to 210-P, and a synchronizer 250, according to an embodiment. The synchronizer 250 is communicatively connected to a first network 220 and a second network 225. The first network 220 and the second network 225 may include, but are not limited to, wired or wireless networks, such as a local area network (LAN), a wide area network (WAN), a metro area network (MAN), the worldwide web (WWW), the Internet, a virtual private network (VPN), any combination thereof, and the like. The first network 220 may be directly connected to the second network 225, or connected via the synchronizer 250.

In an embodiment, the first network 220 is connected to a first CBCE, which includes a plurality of primary machines 100-1 through 100-M, each having one or more logical disks 140. The logical disks 140 may include one or more data disks, root disks, boot disks or any combination thereof, implemented on one or more logical drives or physical disks. The synchronizer 250 may be configured to install an agent, such as a replication agent 130-1 on a primary machine 100-1, or allow such a replication agent 130-1 to be downloaded therefrom. Similarly, in an embodiment, the second network 225 is connected to a second CBCE, which includes a plurality of replicated machines 210-1 through 210-P, each having one or more logical disks 240. The synchronizer 250 may be configured to install an agent, such as a replication agent 230-1 on a replicated machine 210-1, or allow such a replication agent 230-1 to be downloaded therefrom. In the aforementioned examples, CM′ and ‘P’ are integers equal to or greater than 1. In certain embodiments, the first CBCE and the second CBCE may be implemented in a single CBCE.

The synchronizer 250 may be configured to identify a corresponding replicated disk, e.g., a disk 240-1 on a replicated machine 210-1, that corresponds to a disk 140-1 on a primary machine 100-1. In an embodiment, each of the primary and replicated disks 140-1, 240-1 include metadata used to identify that particular disk. A corresponding disk is a disk having related or matching metadata.

In one embodiment, a primary machine 100-1 in the first CBCE includes a plurality of disks 140-1, such as a first primary disk and a second primary disk. In a further embodiment, a primary machine may only comprise a single primary disk, e.g., the primary machine 100-2.

The synchronizer 250 uploads a replication agent, e.g., 130-1, to the primary machine 100-1, which may be executed via a processing circuitry from memory, e.g., the processing circuitry 110 and memory 120 of FIG. 1, and is configured to collect information, such as disk identifying information, from the primary machine 100-1. The information is sent to the synchronizer 250 to allow the synchronizer 250 to initiate a synchronizer action, such as a backup of the first primary disk, on a replicated machine 210-1 in the second CBCE. In some embodiments, the primary and replicated disks do not mirror each other in structure. For example, the replicated machine 210-1 may include a Redundant Array of Independent Disks (RAID) system, where multiple disks are configured to contain a backup of a single primary disk. Alternatively, the replicated machine 210-1 may include a plurality of disks that are distinct from one another, where each disk is configured to back up a different primary disk.

In order for the synchronizer 250 to determine which of the replicated disks correspond to each primary disk, an identifier of the primary disks and the replicated disks is determined. For example, if an instruction is received by the synchronizer to update a replicated disk with a block of data from a primary disk, the replicated machine may become inconsistent with the primary machine if the instruction is not performed on the correct disk. Thus, an identifier for each disk may be determined.

In an embodiment, the identifier includes metadata associated with that primary disk 140-1. The synchronizer 250 is configured to enlarge the primary disk 140-1 by adding storage space, e.g., 145 of FIG. 1, and write metadata thereto to uniquely identify the disk 140-1. Enlarging the disk allows for metadata to be written and associated with a disk even if the disk itself is full. In an embodiment, the disk is a logical disk on a physical drive, where the physical drive is larger than the logical disk. The additional disk space may be created within the same physical drive.

A corresponding replicated disk 240-1 is identified by comparing the metadata of the primary disk 140-1 to metadata of replicated disks of a replicated machine. If no corresponding replicated disk exists, the synchronizer 250 may be configured to create a replicated disk on the replicated machine, create an additional disk space for the replicated disk, and write metadata thereto corresponding to the metadata of the primary disk. Any future replication action, such as backup, access, or updates of files or data on the primary disk may be executed on the corresponding replicated disk by identifying the corresponding disk using the metadata stored in each of the additional disk spaces.

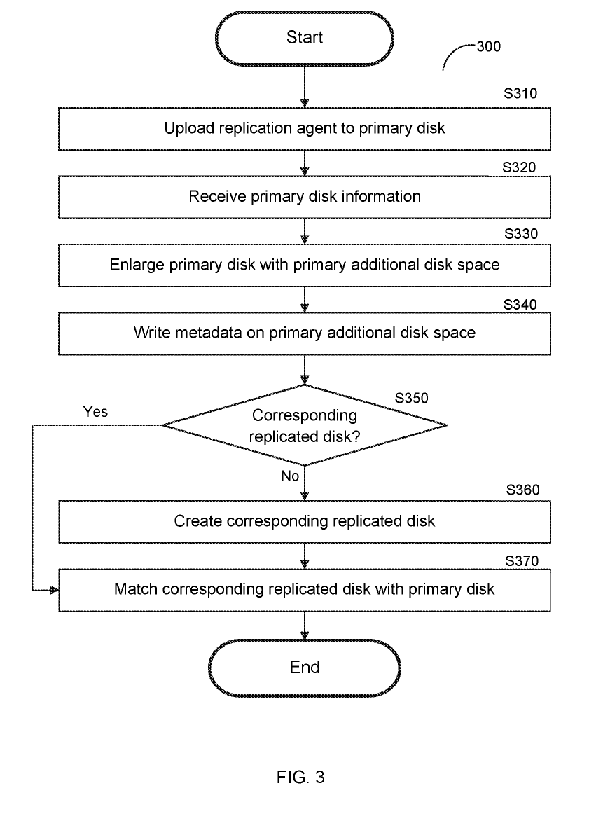

FIG. 3 is a flowchart of a method 300 of identifying a replicated disk corresponding to a primary disk according to an embodiment. At optional S310, a replication agent is uploaded to a primary machine of a first CBCE. The primary machine includes at least one primary disk, where the primary disk may be a logical disk stored on a physical drive. Where a replication agent is already present on the primary disk, no upload may be required.

At S320, identifying information of the primary disk is received, e.g., by a synchronizer from the replication agent. In an embodiment, the identifying information is unique to that primary disk, such that no two primary disks share the same identifying information.

At S330, the primary disk is enlarged to include additional disk space. In an embodiment, the primary disk is a logical disk stored on a larger physical drive, where the enlargement of the additional disk space is stored on the same physical drive. In a further embodiment, the additional disk space is stored on a different physical drive. In some embodiments, the physical drives are within cloud based computing environments (CBCE) that allow for rapid expansion of storage space for disks by distribution of logical disks across multiple physical drives, which may be stored in multiple physical locations.

At S340, metadata corresponding to the primary disk is written to the additional disk space on the primary disk, where the metadata includes identifying information of the primary disk. In some embodiments, the identifier may be a unique identifier which is given only to a single element within the CBCE. The metadata may further include a priority level the primary disk has in a quality of service (QoS) scheme, an identifier of a primary machine associated with the primary disk, a name of the disk, an address of the disk, combinations thereof, and the like.

At S350, it is checked if a corresponding replicated disk is found, e.g., on a replicated machine. The corresponding replicated disk may be identified by accessing additional disk space on replicated machines within a second CBCE. Metadata stored thereon is compared to metadata associated with the primary disk. If a corresponding replicated disk is found, the method continues at S370; otherwise it continues at S360.

At S360, a corresponding replicated disk is created, e.g., on a replicated machine. In an embodiment, the corresponding disk is created as a copy of the primary disk. In a further embodiment, additional disk space is created with the replicated disk, and metadata corresponding to the primary disk is copied and stored within the additional disk space of the replicated disk. In yet a further embodiment, the metadata associated with the replicated disk identifies a match with, though may not be identical to, the metadata associated with the primary disk.

At S370, the corresponding replicated disk is matched to the primary disk based on the metadata shared between the two disks. The matched corresponding replicated disk may be used for replication actions, such as backing up, updating, and accessing the primary disk. For example, if a user wishes to back up new content stored within a primary disk, a corresponding replicated disk may be identified using the metadata from a replicated machine, and the new contents can be sent to the matching replicated disk to be stored thereon. Further, if a user wishes to access data from the primary disk while the primary disk is inaccessible, e.g., due to a power failure, a corresponding replicated disk may be identified using the metadata, and the data may be accesses therefrom instead.

In some embodiments, any of the steps in the method disclosed herein may be performed by a synchronizer or by a replication agent executed on a primary machine, a replicated machine, or any other machine connected to the first or second CBCE, configured to perform any, or all, of the disclosed steps. The steps of the method need not necessarily be performed in the order they are claimed.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for identifying corresponding disks, comprising:
determining identifying information of a primary disk, wherein the primary disk is a logical disk;
causing the primary disk to be enlarged to create a first additional disk space;
causing primary metadata to be written to the first additional disk space, wherein the primary metadata includes the identifying information of the primary disk;
determining a corresponding replicated disk that corresponds to the primary disk by comparing the primary metadata to replicated metadata associated with the replicated disk, wherein the replicated disk is a logical disk; and
matching the corresponding replicated disk with the primary disk.

2. The method of claim 1, further comprising:
creating a corresponding replicated disk that corresponds to the primary disk when no corresponding replicated disk is found.

3. The method of claim 2, wherein the created corresponding replicated disk is a copy of the primary disk.

4. The method of claim 2, further comprising:
causing the replicated disk to be enlarged to create a second additional disk space; and
causing the primary metadata to be written to the second additional disk space;

5. The method of claim 1, wherein the metadata includes at least one of: a unique identifier, a priority level a disk has in a quality of service (QoS) scheme, an identifier of a machine associated with a disk, a name of a disk, and an address of a disk.

6. The method of claim 1, where the primary disk and the replicated disk are stored on at least one physical drive.

7. The method of claim 6, where the physical drive comprises at least one of: a hard disk drive, a solid-state drive, a network-attached storage, and a storage area network disk.

8. The method of claim 1, further comprising:
executing a replication action on the replicated disk based on the metadata.

9. The method of claim 8, wherein the replication action includes at least one of:
backing up data to the replicated disk, updating data to the replicated disk, and accessing data from the replicated disk.

10. A non-transitory computer readable medium having stored thereon instructions for causing a processing circuitry to perform a process, the process comprising:
determining identifying information of a primary disk, wherein the primary disk is a logical disk;
causing the primary disk to be enlarged to create a first additional disk space;
causing primary metadata to be written to the first additional disk space, wherein the primary metadata includes the identifying information of the primary disk;
determining a corresponding replicated disk that corresponds to the primary disk by comparing the primary metadata to replicated metadata associated with the replicated disk, wherein the replicated disk is a logical disk; and
matching the corresponding replicated disk with the primary disk.

11. A system for identifying corresponding disks, comprising:
a processing circuitry; and
a memory, the memory containing instructions that, when executed by the processing circuitry, configure the system to:
determine identifying information of a primary disk, wherein the primary disk is a logical disk;
cause the primary disk to be enlarged to create a first additional disk space;
cause primary metadata to be written to the first additional disk space, wherein the primary metadata includes the identifying information of the primary disk;
determine a corresponding replicated disk that corresponds to the primary disk by comparing the primary metadata to replicated metadata associated with the replicated disk, wherein the replicated disk is a logical disk; and
match the corresponding replicated disk with the primary disk.

12. The system of claim 11, wherein the system is further configured to:
create a corresponding replicated disk that corresponds to the primary disk when no corresponding replicated disk is found.

13. The system of claim 12, wherein the created corresponding replicated disk is a copy of the primary disk.

14. The system of claim 12, wherein the system is further configured to:
cause the replicated disk to be enlarged to create a second additional disk space; and
cause the primary metadata to be written to the second additional disk space;

15. The system of claim 11, wherein the metadata includes at least one of: a unique identifier, a priority level a disk has in a quality of service (QoS) scheme, an identifier of a machine associated with a disk, a name of a disk, and an address of a disk.

16. The system of claim 11, where the primary disk and the replicated disk are stored on at least one physical drive.

17. The system of claim 16, where the physical drive comprises at least one of: a hard disk drive, a solid-state drive, a network-attached storage, and a storage area network disk.

18. The system of claim 11, wherein the system is further configured to:
execute a replication action on the replicated disk based on the metadata.

19. The system of claim 18, wherein the replication action includes at least one of:
backing up data to the replicated disk, updating data to the replicated disk, and accessing data from the replicated disk.

20. A method for identifying corresponding disks, comprising:
determining identifying information of a primary disk, wherein the primary disk is a logical disk;
creating first additional disk space associated with the primary disk;
writing primary metadata to the first additional disk space, wherein the metadata is based upon the identifying information of the primary disk;
determining a corresponding replicated disk that corresponds to the primary disk by comparing the primary metadata to replicated metadata associated with the replicated disk, wherein the replicated disk is a logical disk; and
matching the corresponding replicated disk with the primary disk.
